(19) United States
(12) Patent Application Publication
(10) Pub. No.: US 2016/0007762 A1
(43) Pub. Date: Jan. 14, 2016

(54) GAS COMMUNICATION DEVICE, GAS SUPPLY ASSEMBLY AND GAS SUPPLY ADJUSTMENT METHOD

(71) Applicant: APEX MEDICAL CORP., New Taipei City (TW)

(72) Inventor: Wen Bin SHEN, New Taipei City (TW)

(21) Appl. No.: 14/328,468

(22) Filed: Jul. 10, 2014

(51) Int. Cl. A47C 27/08; F16L 39/00

(52) U.S. Cl. CPC A47C 27/081; F16L 39/00

(57) ABSTRACT

Provided are a gas communication device, a gas supply assembly and a gas supply adjustment method. The gas communication device is connectable to a gas supplier and comprises a main body, an engagement member, a press member and a release member. The press member drives the disengagement of the engagement member from the gas supplier, and the release member is structurally changeable to promote easy removal of the gas communication device from the gas supplier. The gas supply assembly is a combination of the gas communication device and the gas supplier. The gas supply adjustment method is applicable to the adjustment of gas supply and gas exhaust between the gas supply assembly and an air mattress and is characterized by making use of the structural change of the release member to promote the removal of the gas communication device from the gas supplier.

### FIELD OF THE INVENTION

The present invention relates to a gas communication device, a gas supply assembly and a gas supply adjustment method and more particularly to a device, assembly and method applicable to gas supply and exhaust of an air mattress, wherein the gas communication device may be easily connected to and separated from a gas supplier, and the problems associated to the placement of the gas communication device can be prevented.

### BACKGROUND OF THE INVENTION

An air mattress or airbed is a mattress or sleeping pad consisting of one or more inflatable cells or tubes and may generally be categorized into a general purpose air mattress and a medical air mattress. The medical air mattress is particularly suitable for a bedridden patient as it relieves local stress concentration and prevents bedsores.

In practical use, an air mattress set generally comprises a mattress main body, a gas supplier and a gas communication device. The mattress main body has one or more air tubes. The gas supplier comprises an air pump with adjustable air supply and discharge settings. The gas communication device is arranged between the mattress main body and the gas supplier to form air communication between the mattress main body and the gas supplier, such that the gas supplier can inflate or deflate the mattress main body to adjust the hardness/softness of the mattress main body.

In order to enable the connection and separation of the gas communication device and the gas supplier so as to inflate or deflate the mattress main body, the gas communication device may be provided with a quick disassembly and assembly structure. For example, TW Patent No. M427485 discloses a gas delivery connector set comprising a connector holder connected with a gas supplier and a gas delivery connector for rapid connection to and separation from the connector holder, wherein the gas delivery connector has one end connected to the mattress main body via a tube and the other end connected with the connector holder via two hook structures. When the gas delivery connector is inserted into the connector holder, gas communication is formed between the mattress main body and the gas supplier.

Because the gas delivery connector is fastened with the connector holder by two hook structures, when a user tries to remove the gas delivery connector to allow rapid deflation of the air mattress, in particular when a patient is in urgent need of cardiopulmonary resuscitation (CPR), the user has to press both hook structures with two fingers to achieve disengagement, which undesirably makes the operation very inconvenient, and the gas delivery connector cannot be removed without delicate manipulation. In addition, when the two hook structures are pressed by two fingers respectively, the gas delivery connector cannot be automatically ejected or separated from the connector holder, and the user has to pull the gas delivery connector backward to completely remove it from the connector holder. In this regard, the removal operation will be difficult and troublesome if the front portion of the connector is engaged overly tight, and the need of rapid deflation of the air mattress cannot be met properly. Accordingly, there is a need to improve the gas communication device used for connecting the air mattress and the gas supplier.

### SUMMARY OF THE INVENTION

An objective of this invention is to provide a gas communication device, a gas supply assembly, and a gas supply adjustment method applicable to the gas supply and gas exhaust between a gas supplier and an air mattress. The gas communication device may be conveniently and easily connected to or separated from the gas supplier, thereby increasing the gas supply and discharge adjustment efficiency of the air mattress.

To achieve the aforesaid objective, this invention provides a gas communication device connectable between a gas supplier and, for example, an air mattress, to inflate and deflate the air mattress. One embodiment of the gas communication device comprises: a main body connected to the gas supplier, the main body comprising a base and a cover, wherein the base has a gas inlet corresponding to the gas supplier and a gas outlet connected with the air mattress, and the cover being arranged on the base; an engagement member movably disposed in the main body for engaging a corresponding structure on the gas supplier; a press member, which can be manipulated with one finger, operably linked to the engagement member to enable a user to press and manipulate the press member to induce the disengagement of the engagement member from the gas supplier; and at least one release member, such as an elastic structure, with at least a part disposed in the main body. Thus, when the gas communication device is combined with or connected to the gas supplier through the engagement member, the release member is structurally changed such as due to compression and deformed to store mechanical energy (resilience). When the user presses the press member, the engagement member is driven to disengage from the gas supplier, and at the same time the structural change of the release member, such as the release of mechanical energy (resilience), enables the separation of the main body from the gas supplier to promote gas discharge from the air mattress, thereby achieving the purpose of convenient engagement or connection and disengagement or disconnection and increasing the convenience in use.

In one embodiment, this invention provides a gas communication device connected between a gas supplier and an article to be inflated or deflated, such as an air mattress. The gas communication device mainly comprises a main body comprising a base and a cover disposed on the base; an engagement member movably disposed in the main body; a press member operably linked to the engagement member; and at least one release member at least partially disposed in the main body.

In another embodiment, this invention provides a gas supply assembly applicable to an air mattress, mainly comprising: a gas supplier having at least one engagement structure; and a gas communication device which comprises a housing, an engagement member and a release member, the housing having at least one gas inlet in gas communication with the gas supplier, the engagement member being arranged corresponding to the engagement structure such that the housing may be connected to or removed from the gas supplier, the release member being arranged as elastically deformable toward the gas supplier. Accordingly, the engagement member and the engagement structure may be used to engage or combine the gas communication device and the gas supplier; when the engagement member is disengaged from the engagement structure, the compressed and deformed release member may release resilience to promote the separation of the gas inlet of the main body from the gas supply opening of the gas supplier, thereby allowing rapid deflation of the air mattress. In addition, the structural configuration of the engagement structure of the gas supplier enables the gas communication device to be hanged on the gas supplier without complete removal therefrom, so as to overcome the problems associated to the placement of the gas communication device.

In yet another embodiment, this invention provides a method of adjusting gas supply to an air mattress in gas communication with a gas supply assembly which comprises a gas supplier and a gas communication device. The method mainly comprises disengaging the gas communication device from the gas supplier, thereby enabling elastic deformation of a release member to promote the disengagement or removal of the gas communication device from the gas supplier.

### BRIEF DESCRIPTION OF THE DRAWINGS

A more complete understanding of the subject matter can be derived by referring to the detailed description and claims when considered in conjunction with the following figures, wherein like reference numbers refer to similar elements throughout the figures.

FIG. 1 illustrates an exploded view of the gas communication device of one preferred embodiment according to the present invention;

FIG. 2 illustrates another exploded view of the gas communication device of one preferred embodiment according to the present invention;

FIG. 3 illustrates an exploded view of the gas supply assembly of one preferred embodiment according to the present invention;

FIG. 4 illustrates a cross-sectional view of the gas supply assembly of one preferred embodiment according to the present invention;

FIG. 5 illustrates a first operational state of the gas supply assembly of one preferred embodiment according to the present invention; and

FIG. 6 illustrates a second operational state of the gas supply assembly of one preferred embodiment according to the present invention.

### DETAILED DESCRIPTION OF THE INVENTION

Since various aspects and embodiments are merely exemplary and not limiting, after reading this specification, skilled artisans appreciate that other aspects and embodiments are possible without departing from the scope of the invention. Other features and benefits of any one or more of the embodiments will be apparent from the following detailed description and the claims.

The use of “a” or “an” is employed to describe elements and components described herein. This is done merely for convenience and to give a general sense of the scope of the invention. Accordingly, this description should be read to include one or at least one and the singular also includes the plural unless it is obvious that it is meant otherwise.

As used herein, the terms “comprises,” “comprising,” “includes,” “including,” “has,” “having” or any other variation thereof are intended to cover a non-exclusive inclusion. For example, a component, structure, article, or apparatus that comprises a list of elements is not necessarily limited to only those elements but may include other elements not expressly listed or inherent to such component, structure, article, or apparatus.

Furthermore, as used herein, the terms “first,” “second,” “third” and the like are used for distinguishing between or referring identical or similar elements or structures and not necessarily for describing a sequential or chronological order thereof. It should be understood that the terms so used are interchangeable under appropriate circumstances or configurations and that the embodiments of the invention described herein are operable in other sequences than described or illustrated herein. Moreover, the terms “upper,” “lower,” “left,” “right” and the like in the description and the claims are used for describing relative positions of articles or structures and not necessarily limiting the absolute positions thereof; on the contrary, the terms so used are interchangeable under appropriate circumstances or configurations. For example, the position of an upper opening is higher than that of a lower opening, but when the surrounding or orientation has been changed, the upper opening may become the lower opening, and the lower opening may become the upper opening. In addition, in some configurations, the upper opening may also become the left opening or the right opening, vice versa. Similarly, in some configurations, up-down movement can also be implemented as left-right movement or inclined movement.

As used herein, the term “main body” shall describe a main portion of a physical structure, which may optionally comprise a base and a cover removably connected with the base or integrally formed with the base such that the base and the cover are configured as two portions of the main body. In general, the “main body” acts as a reference for the movements of respective movable elements and as a matrix for the connection of various elements or structures.

As used herein, the term “engagement” or the like is interpreted in the broadest sense comprehensible by a person skilled in the art, including but not limited to direct connection or linkage where two elements or structures are in contact with each other and no intermediate exists therebetween, indirect connection or linkage where an intermediate exists between two elements or structures to be connected, and movable connection where the motion of one element or structure is constrained by the other. “Engagement” comprises direct or indirect fitting, fixing, coupling and similar connection configurations and preferably comprises temporary engagement where two mutually engaged structures may be operably linked in a separable or disengageable way. The term “movable engagement” or the like describes the engagement of two structures or objects where one is rotatable or movable relative to the other. The term “engagement member” describes a component, element or part having an engagement structure and being engageable with another component, element or part.

As used herein, the term “movable” or the like refers to an article or a part thereof which may be subject to spatial or orientation change or variation, including movement and rotation. The term “operably linked” or the like describes that the structural or spatial variation of an article or a part thereof causes, directly or indirectly, the structural or spatial variation of another article or a part thereof, whether or not the objects are in contact with each other. As used herein, the term “release,” “separation,” “removal” and the like are used interchangeably to describe the change of two objects or parts thereof from a closer state to a more distant state, including complete separation where separated objects or parts thereof are no longer in contact with each other or partial separation where separated objects or parts thereof are still in contact. Generally, “release,” “separation,” or “removal” describes that the major portions or surfaces of two objects are not connected or adhered to each other.

As used herein, the term “housing” refers to an object for receiving an element or portions thereof. A housing is typically the outmost portion of a device, but not limited thereto. The term “elastic connection” refers to direct or indirect connection of two structures where a force may be imposed to any one of them to change the relative spatial relationship of the structures, and after the force disappears, the original relative spatial relationship is resumed. As used herein, the term “deformation” describes structural or configuration variation or change of an object, for example a release member, such as length variation at different states or conditions.

As used herein, the term “connect,” “connected,” “connected to” or “connected with” means “combined, joined, linked or assembled together,” and includes direct connection where no intermediate (e.g. a gasket or washer) exists and indirect connection where an intermediate exists between two elements to be connected. In addition, when different components are connected, these components may form an integral, one-piece structure such as by integration in which different components act as different parts or portions of the integral structure, or these components may be distinct and separate components connected together. Unless otherwise specified, means for joining distinct and separate components together includes interlocking, engagement, fastening, mortise and tenon joint, or any other connection means known and understood in the mechanical arts.

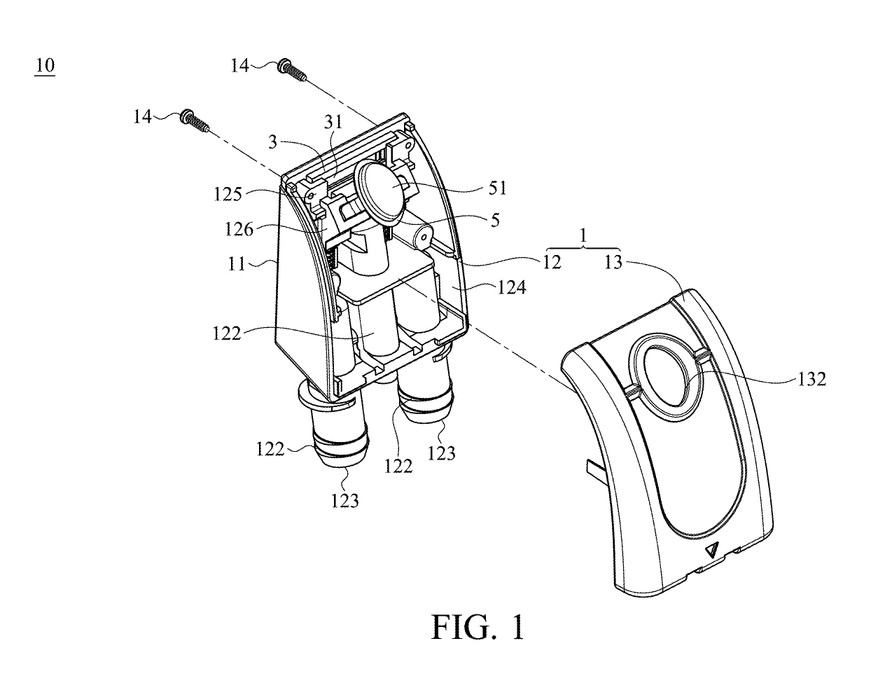

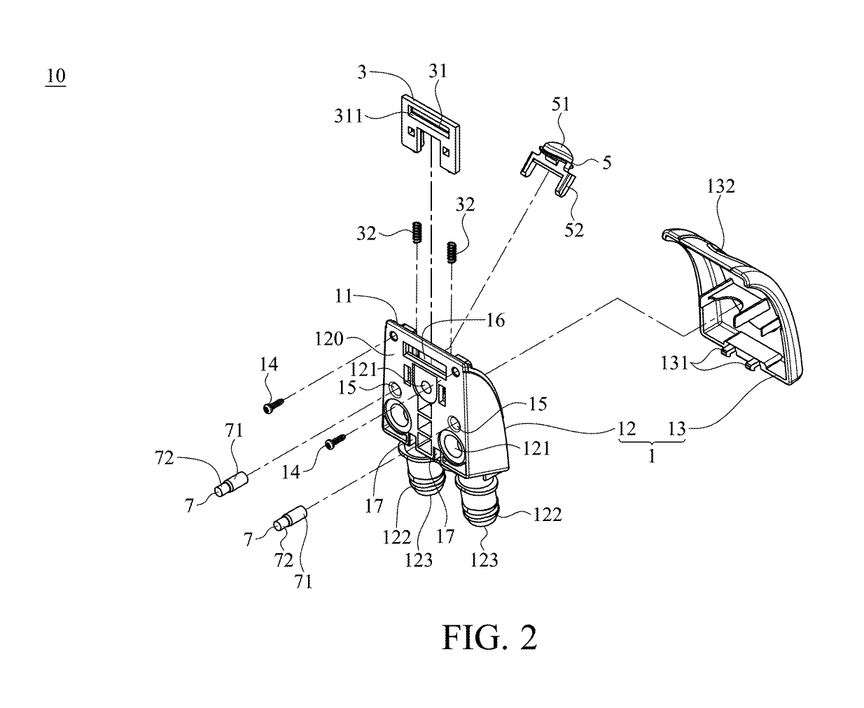

As illustrated in FIGS. 1 to 3, the gas communication device 10 of one embodiment of this invention is a connector which can be rapidly connected to and removed from a gas supplier 20. When the gas communication device 10 and the gas supplier 20 are used together, they as a whole form a gas supply assembly 100 for inflating an air mattress. As illustrated in FIGS. 1 and 2, in a preferred embodiment, the gas communication device 10 comprises a main body 1, an engagement member 3, a manipulative member 5 (such as a press member) and at least one release member 7.

In this embodiment, the main body 1 may be connected to the air mattress via gas delivery tubes and be rapidly connected to the gas supplier 20. The main body 1 may be formed by the assembly or integrated molding of multiple sub-components. For example, the main body 1 may be a housing 11, which is preferably composed of a base 12 and a cover 13 connected with the base 12, configured for completely or partially receive the aforesaid engagement member 3, manipulative member 5 and release member 7.

The base 12 has a connection plane 120 facing towards the gas supplier 20, and one or more gas inlets 121 may be formed on the connection plane 120. The channel defined by the gas inlet 121 may be extended to other surfaces of the base 12 to form one or more gas delivery pipe parts 122 with one end communicated with the gas inlet 121 and the other end forming a gas outlet 123 connected with a gas delivery tube. In addition, as illustrated in FIG. 1, one side of the base 12 opposite to the connection plane 120 defines a receiving space 124 through which the gas delivery pipe part 122 is extended to the bottom of the base 12.

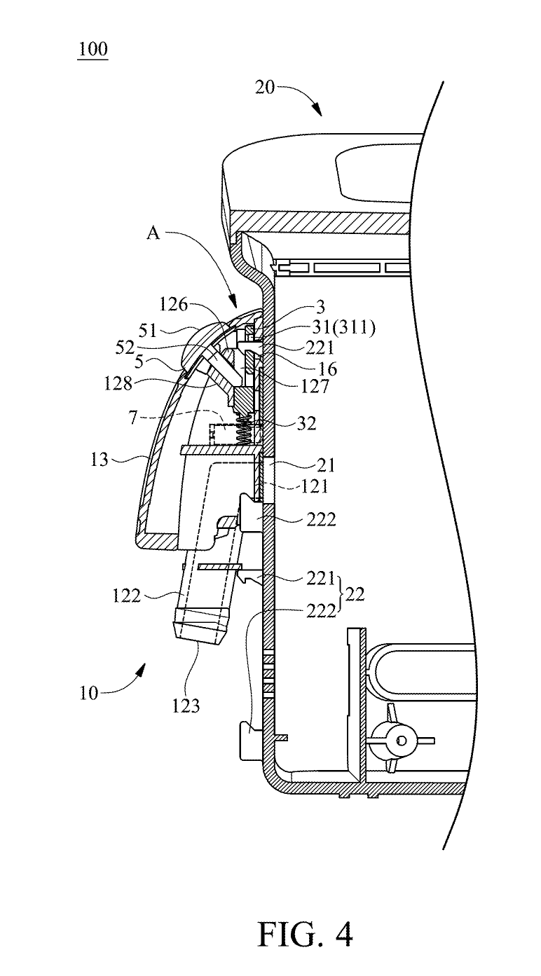

As illustrated in FIGS. 1 and 4, the receiving space 124 may be provided with a longitudinal guide block 125 and an oblique guide block 126 therein. The longitudinal guide block 125 defines a longitudinal slide slot 127 in which the engagement member 3 is slidably arranged. The oblique guide block 126 defines an oblique slide slot 128 with one end communicated with the longitudinal slide slot 127, such that the press member or manipulative member 5 or a part thereof may be slidably disposed in the oblique slide slot 128. Using such design and configuration, when a user presses the manipulative member 5, the manipulative member 5 slides along the oblique slide slot 128 and then abuts against the engagement member 3 so as to drive the engagement member 3 to slide longitudinally along the longitudinal slide slot 127.

The cover 13 may be assembled with and covered on the base 12. In particular, the cover 13 may be configured as a curved shape or any shape that can be held by the user with one hand easily and be combined with the base 12 to cover the receiving space 124. To combine the cover 13 and the base 12, as illustrated in FIG. 2 for example, one or more hooks 131 on the cover 13 may be engaged or interlocked with the corresponding structures on the base 12, and one or more fastening elements 14, such as screws, may be used to fasten the base 12 and the cover 13. Particularly, in one embodiment, the cover 13 is defined thereon with a circular or elliptic push button hole 132, such that after the base 12 is combined with the cover 13, a portion of the manipulative member 5, e.g. the press member, is exposed from the cover 13 through the push button hole 132, thereby allowing the user to actuate or press the manipulative member 5 with one finger to actuate the engagement member 3.

The engagement member 3 is received in the housing 11 such as in an elastically movable manner for engaging the gas supplier 20. In particular, the engagement member 3 may be configured as a rigid sheet with a U-shape or any other shape movably disposed in the longitudinal slide slot 127, and the engagement member 3 is provided with an engagement part 31 for engaging the gas supplier 20, such as an engagement slit 311 formed on the engagement member 3. However, the engagement part 31 may also be configured as other structures capable of forming engagement.

The tips at two sides of the engagement member 3 may be respectively connected with an elastic member 32, such as a spiral spring or other springs, arranged at the bottom of the longitudinal slide slot 127 of the base 12, such that the engagement member 3 may be arranged in the longitudinal slide slot 127 in an elastically movable manner to slide between an engagement orientation and a disengagement orientation.

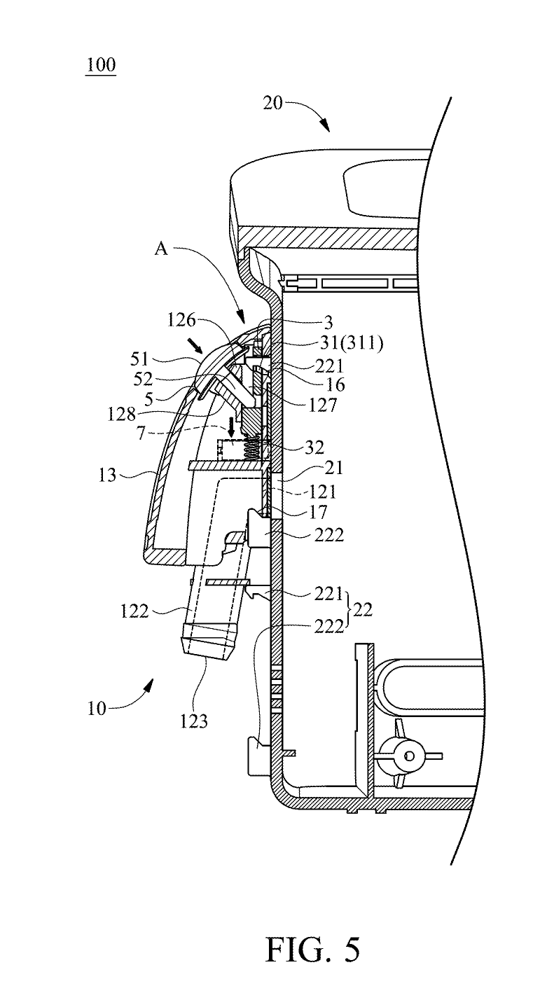

As illustrated in FIGS. 1 and 2, the manipulative member 5, such as a structure to be pressed by the user, may be manipulated by the user with one finger so as to drive the sliding operation of the engagement member 3, as indicated by the arrow in FIG. 5. Preferably, the press member or manipulative member 5 is a circular push button 51 connected from the bottom with two arms 52, such as two rod-like structures extended downwardly from two sides of the push button 51. The two arms 52 are movably arranged in the oblique slide slot 128 of the base 12 with their tips obliquely rested on or abutted against the engagement member 3, and the push button 51 is protruded from the push button hole 132 of the cover 13. Thus, as illustrated in FIG. 5, when the user presses the push button 51 with one finger, the manipulative member 5 slides along the oblique slide slot 128 toward the base 12, and downward component of force from the arms 52 drives longitudinal or downward movement of the engagement member 3, thus disengaging the engagement part 31 from the gas supplier 20. Conversely, to combine the gas communication device 10 and the gas supplier 20, the user may align the engagement part 31 of the engagement member 3 of the gas communication device 10 to the corresponding engagement structure 22 on the gas supplier 20 (an embodiment allowing convenient alignment is described below), and push the gas communication device 10 toward the gas supplier 20, during which the engagement part 31 elastically slides downward via the elastic member 32 along the longitudinal slide slot 127 and forms engagement with the engagement structure 22 after it is elastically repositioned, allowing easy and convenient assembly of the gas communication device 10 and the gas supplier 20.

The release member 7 is a component for promoting the separation of the gas communication device 10 from the gas supplier 20. It is structurally changeable, such as generating elastic force, during the disengagement between the engagement member 3 and the engagement structure 22, so as to facilitate the removal of the gas communication device 10 from the gas supplier 20 and reduce user's effort required to withdraw the gas communication device 10, thereby making the removal and separation easier.

The release member 7 is at least partially disposed in the main body 1. As illustrated in FIG. 2, in a preferred embodiment, the base 12 of the main body 1 is provided with one or more receiving holes 15 on the connection plane 120 for correspondingly receiving one or more release members 7. In one embodiment, two release members 7 are respectively arranged in left and right receiving holes 15 formed symmetrically relative to the longitudinal axis of the main body 1. When the release members 7 have not been deformed or structurally changed, a part thereof is received in the corresponding receiving hole 15 and the other part is exposed therefrom.

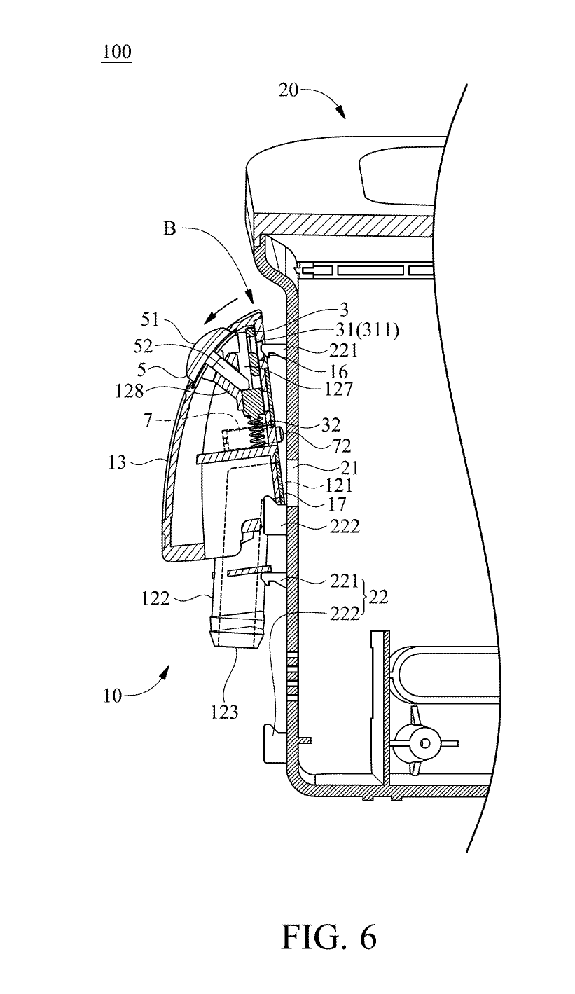

After the gas communication device 10 and the gas supplier 20 have been combined, the release member 7 will be squeezed in between the main body 1 and the gas supplier 20 and thereby compressed to store mechanical energy for promoting the separation of the gas supplier 20 and the gas communication device 10. Specifically, the release member 7 may be an elastic structure or elastic pin made of spring or elastic material. In one embodiment, the release member 7 has a cylindrical structure with a first portion 71 and a second portion 72. The first portion 71 has a diameter greater than that of the second portion 72, such that first portion 71 may be retained within the receiving hole 15, and the second portion 72 is elastically deformable when pressed. Therefore, when the engagement member 3 is disengaged from the gas supplier 20, the mechanical energy (resilience) produced by the deforming release member 7 may promote the separation of the gas communication device 10 from the gas supplier 20, as illustrated in FIG. 6.

In the gas communication device 10 of the present invention, the structural design and configuration of the main body 1, the engagement member 3, the press member 5 and the release member 7 allows rapid connection of the main body 1, such as the housing 11, via the engagement member 3 onto a side wall of the gas supplier 20, such that the gas inlet 121 is communicated with the gas supply opening of the gas supplier 20 to form a gas supply assembly 100 suitable for an air mattress and useful for inflating the air mattress or adjusting the hardness/softness of the air mattress. When there is a need for rapid deflation of the air mattress, the user only needs to press the manipulative member 5 with one finger to move the engagement member 3 disengage the engagement member 3 from the gas supplier 20. Meanwhile, the deformation or structural change of the release member 7 facilitates the movement or rotation of the gas communication device 10 away from the gas supplier 20 so as to save the effort required to remove or unplug the gas communication device 10 and achieve the purpose of convenient separation to stop gas supply to the air mattress or allow gas discharge from the air mattress.

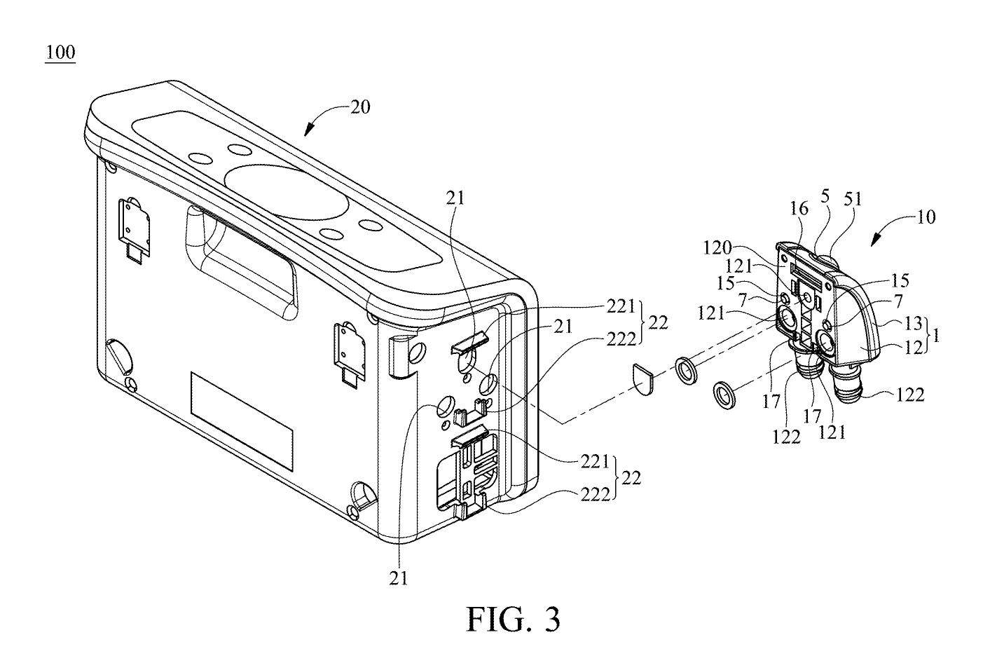

In one embodiment, this invention provides a gas supply assembly 100 composed of the aforesaid gas communication device 10 and gas supplier 20. FIGS. 2 and 3 respectively illustrate the preferred combination and separation configurations of the two components.

The connection plane 120 of the housing 11 is provided with a first opening 16, such as an upper opening, corresponding to the engagement part 31, such as an engagement slit 311, of the engagement member 3. The engagement member 3 is arranged in a manner movable relative to the first opening 16, such as vertically movable or slidable parallel to the connection plane 120. Thus, when the first engagement portion 221, such as an upper engagement portion, of the gas supplier 20 is passed through the first opening 16, the inclined plane design enables the engagement member 3 to be pushed downward and then repositioned and thereby engaged with the first engagement portion 221. Oppositely, the engagement member 3 may be driven to disengage from the first engagement portion 221. During the disengagement process, the first engagement portion 221 is not obstructed by the engagement member 3 and may be removed therefrom through the first opening 16, and the release member 7 provides assistance to more easily remove the engagement member 3 from the first engagement portion 221 so as to separate the gas communication device 10 from the gas supplier 20.

As illustrated in FIG. 2, the housing 11 can further be provided with at least one second opening 17, such as a lower opening. For example, two second openings 17 can be formed at the bottom of the housing 11 symmetrically relative to the longitudinal axis of the main body 1 to facilitate the alignment of the gas communication device 10 to the gas supplier 20 and temporarily mount or hang the gas communication device 10 on the gas supplier 20.

As shown in FIGS. 5 and 6, when the second engagement portion 222, such as lower engagement portion, of the gas supplier 20 has been passed through the two second openings 17, the configuration of the second openings 17 and the second engagement portion 222 enables movable engagement between the housing 11 and the gas supplier 20, thereby preventing the gas communication device 10 from being completely separated or fallen from the gas supplier 20.

It should be understood that the above-described embodiments are simply illustrative of the preferred arrangement of this invention, particularly the arrangement of the vertical type gas supplier 20, but other spatial arrangements or configurations can also be employed. For example, for a gas supplier 20 with a horizontal arrangement, the first opening 16 and the second opening 17 may be respectively configured as a left opening and a right opening. In addition, in other embodiments, the first opening 16 and the second opening 17 may be configured as oblique arrangement or front-and-rear arrangement relative to the longitudinal axis of the gas supplier 20. That is, unless otherwise specified, the positions of various structures and elements of this invention are adjustable according to the need and circumstance in actual use and not limited to those disclosed in this specification and drawings.

As illustrated in FIGS. 3 and 4, the gas supplier 20 and the gas communication device 10 are combined to form the gas supply assembly 100 for the air mattress. One side of the gas supplier 20 is provided with one or more gas supply openings 21, any of which may be sealed by a rubber seal if needed. When the gas communication device 10 is mounted to one side of the gas supplier 20, the gas supply opening 21 is matched and communicated with the gas inlet 121 of the gas communication device 10, such that gas outputted from the gas supply opening 21 is passed through the gas inlet 121, the gas delivery pipe part 122 and the gas delivery tube to the air mattress for inflation.

Corresponding to the engagement member 3 of the gas communication device 10, the gas supplier 20 is preferably provided at one side with one or more engagement structures 22, such as two pairs of engagement structures 22 arranged at the upper and lower portions illustrated in FIG. 3. The engagement member 3 may be correspondingly engaged with any one of the engagement structures 22. Therefore, the structural correspondence between the engagement structures 22 and the engagement member 3 allows the user to mount the gas communication device 10 to any desirable position on the gas supplier 20 to carry out different gas adjustment functions. In addition, the release member 7 is structurally deformable, such as from a compressed state to a stretched state, when at least a part of the engagement structures 22 is disengaged from the engagement member 3, so as to promote the separation of the gas communication device 10 from the gas supplier 20, as illustrated in FIG. 6.

In addition, each engagement structure 22 may have a first engagement portion 221 and a second engagement portion 222, as illustrated in FIG. 3. The first engagement portion 221 is preferably configured as a first hook protrudingly arranged on the surface of the gas supplier 20 and facing downward, such that it may secure the engagement member 3 from the lower edge of the engagement part 31, such as the engagement slit 311, through the first opening 16 of the housing 11, making the gas communication device 10 secured at one side of the gas supplier 20, as illustrated by FIG. 4.

When the user presses the push button 51 of the press member 5 with one finger, the press member 5 slides obliquely into the main body 1, as illustrated in FIG. 5, such that the downward component of force from the arms 52 pushes the engagement member 3 to disengage the engagement part 31 and the first engagement portion 221. Conversely, the first engagement portion 221 can be engaged with the engagement member 3 through the first opening 16 by the operation described above.

The second engagement portion 222 is preferably configured as a second hook protruded upward. When the user wants to connect the gas communication device 10 to the gas supplier 20, he or she may first mount the housing 11 on the second engagement portion 222 through the second opening 17, such that the second hook of the second engagement portion 222 hooks and secures the second opening 17. Thus, by simply pushing the gas communication device 10 toward the gas supplier 20, the first engagement portion 221 and the engagement member 3 can be correspondingly engaged to easily and firmly connect the gas communication device 10 to one side of the gas supplier 20, greatly simplifying the alignment process.

Refer back to FIGS. 5 and 6. With the engagement structure 22 at one side of the gas supplier 20, the gas communication device 10 can be arranged relative to the gas supplier 20 at a first orientation A (engaged state) and a second orientation B (partially separated state).

At the first orientation A, the first opening 16 (e.g. the upper opening), the second opening 17 (e.g. the lower opening) and the engagement member 3 are all engaged with the engagement structure 22, and the gas inlet 121 of the gas communication device 10 is, with or without a washer, in airtight communication with the gas supply opening 21 of the gas supplier 20. At the second orientation B, the engagement member 3 of the gas communication device 10 is separated from the first engagement portion 221, and the second opening 17 is secured by the second engagement portion 222, such that the gas communication device 10 can be obliquely rested on the gas supplier 20 at a partial separation configuration illustrated in FIG. 6. Accordingly, this embodiment allows partial separation of the gas communication device 10 from the gas supplier 20 and terminates the gas communication therebetween. In addition, at this orientation, the inclined plane of the second engagement portion 222 in conjunction with the second opening 17 allows the gas communication device 10 to be obliquely mounted to one side of the gas supplier 20 and convenient placement of the gas communication device 10, avoiding damage due to improper placement, and allows rapid combination of the gas communication device 10 and the gas supplier 20 whenever needed.

Based on the above illustrations and descriptions, this invention further provides a method of adjusting gas supply to an air mattress, which is particularly useful for adjusting gas supply or gas exhaust of the air mattress in gas communication with the above-recited gas supply assembly 100, for example. The method comprises first disengaging the gas communication device 10 from the gas supplier 20, thereby allowing deformation or structural change of the release member 7 to promote the separation of the gas communication device 10 from the gas supplier 20, with the assistance of the release member 7 pushing against the gas supplier 20. Therefore, by employing the method of adjusting gas supply to the air mattress, the user can more easily remove the gas communication device 10 from the gas supplier 20 completely, or separate the gas communication device 10 partially from and hang it on the gas supplier 20, so as to simplify the adjustment of gas supply and gas exhaust of the air mattress. In addition, the method of adjusting gas supply to the air mattress is also useful for the adjustment of gas supply or gas exhaust between the air mattress and the gas supply assembly not yet in gas communication, which mainly comprises first mounting or movably engaging the gas communication device, which is connected to the air mattress via a gas delivery tube, by one end, such as by the lower portion, to the gas supplier, and then pushing the gas communication device toward the gas supplier to engage the opposite end, such as the upper portion, with the gas supplier, so as to firmly combine the gas supplier and the gas communication device from two ends and form gas communication therebetween.

The above detailed description is merely illustrative in nature and is not intended to limit the embodiments of the subject matter or the application and uses of such embodiments. Moreover, while at least one exemplary embodiment has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments. Also, various changes can be made in the function and arrangement of elements without departing from the scope defined by the claims, which include known equivalents and foreseeable equivalents at the time of filing this patent application.

What is claimed is:

1. A gas communication device, comprising:
a main body comprising a base and a cover disposed on the base;
an engagement member movably disposed in the main body;
a press member operably linked to the engagement member; and
at least one release member at least partially disposed in the main body.

2. The gas communication device of claim 1, wherein the base has a receiving hole and the release member is at least partially disposed in the receiving hole.

3. The gas communication device of claim 1, wherein the release member is an elastic structure.

4. The gas communication device of claim 3, wherein the elastic structure has a cylindrical structure with a first portion and a second portion, the first portion having a diameter greater than that of the second portion.

5. The gas communication device of claim 1, comprising two release members arranged relative to a longitudinal axis of the main body.

6. The gas communication device of claim 5, wherein the release members are deformable when compressed.

7. The gas communication device of claim 1, wherein the base has a gas inlet and an extended gas delivery pipe part.

8. The gas communication device of claim 1, wherein the press member has two sides respectively provided with an arm obliquely rested on the engagement member.

9. The gas communication device of claim 1, wherein the engagement member has a U-shaped structure having two ends in elastic connection with the base via a spring such that the engagement member is elastically received in the base.

10. A gas communication device detachably connected with a gas supplier, the gas communication device comprising:
a housing having a first opening;
an engagement member configured to be movable relative to the first opening of the housing to allow connection of the housing to the gas supplier or removal of the housing from the gas supplier; and
at least one release member for promoting removal of the housing from the gas supplier.

11. The gas communication device of claim 10, wherein the engagement member is elastically connected with the housing.

12. The gas communication device of claim 10, further comprising a manipulative member for actuating the engagement member.

13. The gas communication device of claim 12, wherein the manipulative member is a push button.

14. The gas communication device of claim 10, wherein the release member is an elastic pin.

15. The gas communication device of claim 10, wherein the release member is at least partially disposed in the housing.

16. The gas communication device of claim 10, wherein the housing further comprises a second opening in movable engagement with the gas supplier.

17. A gas supply assembly for an air mattress, comprising:
a gas supplier comprising an engagement structure; and
a gas communication device comprising a housing, an engagement member and a release member, wherein the housing comprises at least one gas inlet in gas communication with the gas supplier, the engagement member being arranged corresponding to the engagement structure, such that the housing may be connected to or removed from the gas supplier, and wherein the release member is arranged as being deformable toward the gas supplier.

18. The gas supply assembly of claim 17, wherein the housing has a receiving hole for receiving the release member.

19. The gas supply assembly of claim 17, wherein the release member elastically deforms when the engagement structure and the engagement member are disengaged, thereby promoting the separation of the gas communication device from the gas supplier.

20. The gas supply assembly of claim 17, wherein the gas communication device is switchable relative to the gas supplier between a first orientation and a second orientation, and wherein the gas communication device is airtightly connected with the gas supplier at the first orientation, and the engagement member is disengaged from the engagement structure at the second orientation.

21. The gas supply assembly of claim 20, wherein the engagement structure comprises an upper engagement portion and a lower engagement portion, the housing comprises an upper opening and a lower opening respectively corresponding to the upper engagement portion and the lower engagement portion, and the engagement member is movably arranged to enable engagement or disengagement of the upper engagement portion and the engagement member through the upper opening.

22. The gas supply assembly of claim 21, wherein the upper engagement portion is engaged with the engagement member through the upper opening and the lower engagement portion is engaged with the housing through the lower opening at the first orientation, and wherein the upper engagement portion is disengaged from the engagement member and the lower engagement portion is in movable engagement with the housing at the second orientation.

23. A method of adjusting gas supply to an air mattress in gas communication with a gas supply assembly which comprises a gas supplier and a gas communication device, the method comprising disengaging the gas communication device from the gas supplier thereby enabling deformation of a release member to promote the disengagement of the gas communication device from the gas supplier.
